(19) United States
(12) Patent Application Publication
(10) Pub. No.: US 2014/0352304 A1
(43) Pub. Date: Dec. 4, 2014

(54) HYBRID SOLAR FIELD

(71) Applicant: ABENGOA SOLAR LLC, Lakewood, CO (US)

(72) Inventors: Diego Arias, Lakewood, CO (US); Cristina Prieto Rios, Seville (ES); Raul Mateos Dominguez, Lakewood, CO (US); Brian Luptowski, Lakewood, CO (US); William Seidel, Lakewood, CO (US)

(73) Assignee: Abengoa Solor LLC, Lakewood, CO (US)

(21) Appl. No.: 14/241,385

(22) PCT Filed: Aug. 29, 2012
(86) PCT No.: PCT/US2012/052846

§ 371 Date: Aug. 18, 2014

Related U.S. Application Data
(60) Provisional application No. 61/529,124, filed on Aug. 30, 2011.

(51) Int. Cl. F03G 6/06

(52) U.S. Cl. CPC F03G 6/067; F03G 6/06; F03G 2006/061
USPC 60/641.15; 60/645

(57) ABSTRACT

A concentrating solar power plant utilizes two heat transfer fluids. A first heat transfer fluid is heated in a field of concentrating solar collectors. A second heat transfer fluid is heated through a heat exchanger using heat imparted from the first heat transfer fluid. The second heat transfer fluid is then further heated, for example in a second field of concentrating solar collectors, and power is generated utilizing thermal energy extracted from the second heat transfer fluid. The second heat transfer fluid may be a solar salt, and may thus have a higher working temperature than the first heat transfer fluid. The power plant may realize the power generation efficiency improvements offered by utilizing a high temperature working fluid, while at least some of the plant does not require backup heating to protect against freezing events.

### BACKGROUND

Concentrating solar power plants can generate significant amounts of electrical power using energy from the sun, and without consuming significant fossil fuels. In one kind of concentrating solar power plant, a heat transfer fluid is circulated through a field of concentrating solar collectors to heat the heat transfer fluid. The heat transfer fluid is then passed to a power block, which generates electrical power utilizing heat extracted from the heat transfer fluid.

The power block may use a conventional steam-based power cycle such as a Rankine cycle. The efficiency of the power block is dependent on the highest temperature reached by the heat transfer fluid. In general, the higher the temperature reached by the heat transfer fluid, the more efficient the power generation.

### SUMMARY

According to one aspect, a solar power generation system comprises a first field of concentrating solar collectors, and a first heat transfer fluid circulating through the first field of concentrating solar collectors. The first heat transfer fluid is heated by the first field of concentrating solar collectors, and the first heat transfer fluid also circulates through a heat exchanger. The system further comprises a second field of concentrating solar collectors, and a power generation block. A second heat transfer fluid circulates through the second field of concentrating solar collectors, the heat exchanger, and the power generation block. The heat exchanger transfers thermal energy to the second heat transfer fluid from the first heat transfer fluid to heat the second heat transfer fluid from a first temperature to a second temperature. The second field of concentrating solar collectors heats the second heat transfer fluid from the second temperature to a third temperature, and the power generation block generates electrical power utilizing thermal energy extracted from the second heat transfer fluid.

In some embodiments, the second heat transfer fluid is a molten salt. In some embodiments, the first heat transfer fluid has a maximum usable operating temperature of less than 450° C. In some embodiments, the first heat transfer fluid has a maximum usable operating temperature, and the second heat transfer fluid is heated in the secondary concentrating solar heater to a temperature higher than the maximum usable operating temperature of the first heat transfer fluid. In some embodiments, the solar power generation system further comprises a hot storage tank and a cold storage tank, and the second heat transfer fluid flows from the secondary concentrating solar heater to the hot storage tank, and then to the power generation block, and the second heat transfer fluid flows from the power generation block to the cold storage tank and then to the heat exchanger. The field of concentrating solar collectors may include collectors of one or more types selected from the group consisting of parabolic trough solar collectors, Fresnel collectors, and nonimaging collectors. In some embodiments, the field of concentrating solar collectors includes at least one parabolic trough solar collector. In some embodiments, the field of concentrating solar collectors includes collectors of more than one type. The secondary concentrating solar heater may include a second field of concentrating solar collectors. The second field of concentrating solar collectors may include at least one parabolic trough solar collector. In some embodiments, the secondary concentrating solar heater comprises a field of mirrors that reflect solar radiation to a common location, and the second heat transfer fluid circulates through the common location, the heat exchanger, and a power generation block.

In some embodiments, the solar power generation system further includes a bypass of the secondary concentrating solar heater, and when the bypass is not utilized, the second heat transfer fluid circulates through the secondary concentrating solar heater, the heat exchanger, and the power generation block, and when the bypass is utilized, the second heat transfer fluid circulates through the heat exchanger and the power generation block without circulating through the secondary concentrating solar heater. In some embodiments, the solar power generation system further includes a bypass of the heat exchanger, and when the bypass is not utilized, the second heat transfer fluid circulates through the heat exchanger, the secondary concentrating solar heater, and the power generation block, and when the bypass is utilized, the second heat transfer fluid circulates through the secondary concentrating solar heater and the power generation block without flowing through the heat exchanger. In some embodiments, the power generation block uses a working fluid, and the working fluid is heated using at least some of the thermal energy extracted from the second heat transfer fluid.

According to another aspect, a method of generating electrical power includes passing a first heat transfer fluid through a field of concentrating solar collectors to heat the first heat transfer fluid, passing the first heat transfer fluid through a heat exchanger to impart heat to a second heat transfer fluid, passing the second heat transfer fluid through a secondary concentrating solar heater to further heat the second heat transfer fluid, passing the second heat transfer fluid to a power block that generates electrical power utilizing thermal energy extracted from the second heat transfer fluid, passing the second heat transfer fluid back to the heat exchanger to be re-heated. The first heat transfer fluid may be heated by the field of concentrating solar collectors to a maximum temperature less than 450° C. The second heat transfer fluid may be heated by the secondary concentrating solar heater to a temperature greater than 450° C. In some embodiments, the second heat transfer fluid is heated by the secondary concentrating solar heater to a temperature greater than the maximum usable operating temperature of the first heat transfer fluid. In some embodiments, the method further includes passing the second heat transfer fluid through a hot storage tank during flow of the second heat transfer fluid from the secondary concentrating solar heater to the power block. In some embodiments, the method further includes passing the second heat transfer fluid through a cold storage tank during flow of the second heat transfer fluid from the power block to the heat exchanger. In some embodiments, passing the second heat transfer fluid through a secondary concentrating solar heater comprises passing the second heat transfer fluid through a second field of concentrating solar collectors. In some embodiments, the method further includes directing solar radiation to a common location from a field of mirrors, and passing the second heat transfer fluid through a secondary concentrating solar heater comprises passing the second heat transfer fluid through the common location. In some embodiments, the power block uses a working fluid, and the method further comprises heating the working fluid using at least some of the heat extracted from the second heat transfer fluid

### BRIEF DESCRIPTION OF THE DRAWINGS

FIG. 1 schematically illustrates an example of a conventional concentrating solar power plant.

FIG. 2 schematically illustrates a concentrating solar power plant in accordance with embodiments of the invention.

FIG. 3 shows example temperature histories of first and second heat transfer fluids and as they circulate within the system of FIG. 2.

FIG. 4 illustrates a concentrating solar power plant in accordance with other embodiments.

### DETAILED DESCRIPTION

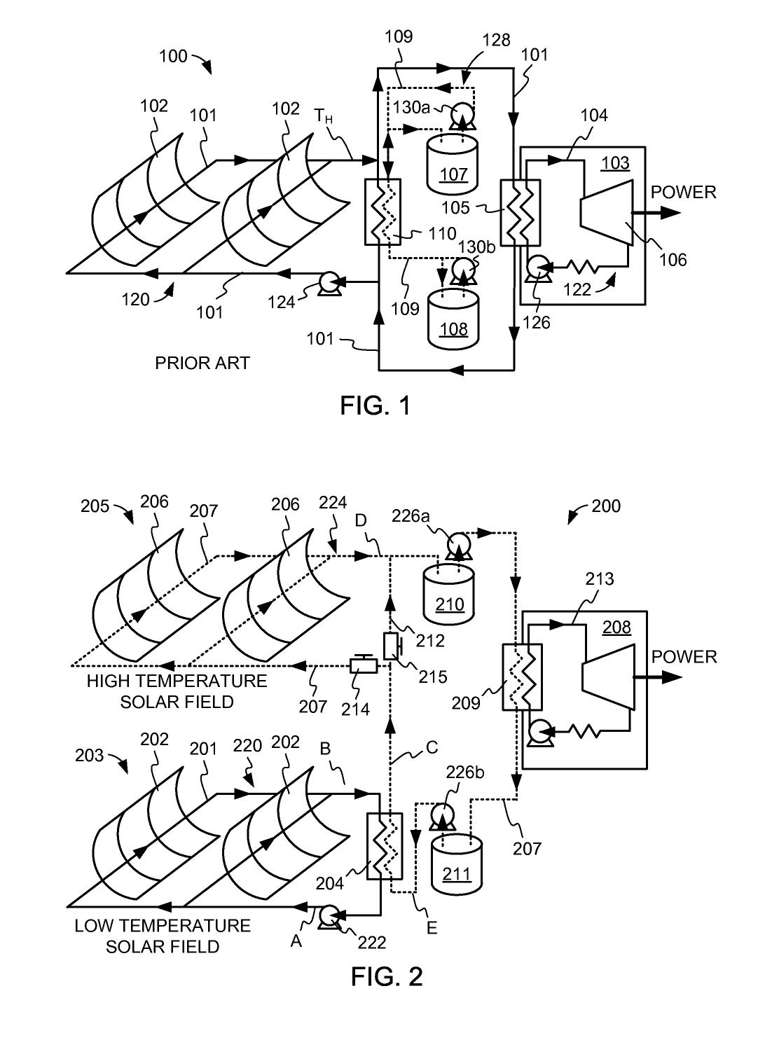

FIG. 1 illustrates an example of a conventional concentrating solar power plant 100. A primary heat transfer fluid 101 is circulated within a primary heating loop 120 that extends through a field of concentrating solar collectors 102. The path of the primary heating loop 120 is indicated by a solid line, with arrowheads to indicate flow direction of the heat transfer fluid 101, which may be circulated by one or more pumps 124. While only two collector modules are illustrated in FIG. 1, the field of collectors may include thousands of collector modules. The primary heat transfer fluid 101 may be a commercially-available, for example a biphenyl/diphenyl oxide (DPO) eutectic mixture such as Therminol-VP1™, available commercially from Solutia, Inc. of St. Louis, Mo., USA, or a dimethyl polysiloxane fluid such as Syltherm 800™, available from Dow Corning Corporation of Midland, Mich., USA. The primary heat transfer fluid 101 is heated by the concentrating solar collectors 102, and is then circulated to a power block 103, which generates power using heat extracted from the heat transfer fluid. In the example shown, a working fluid 104 circulates within an energy loop 122, driven by one or more pumps 126. The path of the power loop 122 is indicated by a solid line, with arrowheads to indicate flow direction of the working fluid 104. The working fluid 104 may comprise, for example, water that is heated in one or more heat exchangers 105, to a vapor state such as steam, which is used to turn a turbine 106, producing mechanical power that may be used to drive an electric generator (not shown). Some conventional power loops comprise multiple turbines and multiple steam extractions in order to increase the efficiency of the power generation system.

The power plant 100 may include hot and cold thermal energy storage tanks 107 and 108, respectively, that contain and exchange a second heat transfer fluid 109. The second heat transfer fluid 109 is exchanged back and forth between the hot and storage tanks 107 and 108 through a transfer system 128, for example driven by pumps 130a and 130b. The hot and cold storage tanks 107 and 108 enable the power plant 100 to store energy and better match its power generation to expected loads. While only single hot and cold storage tanks are illustrated in FIG. 1, the thermal energy storage system may include multiple steps of parallel hot and cold tanks. The path of the secondary heat transfer fluid through the transfer system 128 is indicated by a dotted line, with arrowheads to indicate flow direction of the second heat transfer fluid 109. The second heat transfer fluid 109 may be a molten solar salt, such as a mixture of sodium and potassium nitrates. During times when more solar energy is available than is needed for power generation, the second heat transfer fluid 109 may be pumped from the cold storage tank 108 to the hot storage tank 107 through a second heat exchanger 110, where the second heat transfer fluid 109 is heated by the transfer of thermal energy from the primary heat transfer fluid 101. During times when it is desired to generate more power from the power block 103 than is available from the field of solar collectors 102, for example during the evening and nighttime hours or other times when sunlight is not available, the second heat transfer fluid 109 may be pumped from the hot storage tank 107 to the cold storage tank 108, heating the primary heat transfer fluid 101 via the second heat exchanger 110, and the primary heat transfer fluid 101 can then be pumped to the power block 103 for power generation.

Both the primary and secondary heat transfer fluids 101 and 109 remain in liquid states. For example, the hot storage tank 107 may be maintained at a temperature of about 380° C., and the cold storage tank 108 may be maintained at a temperature of about 300° C., well above the freezing temperature of the molten salt. The primary heat transfer fluid 101 may be heated to a temperature T_{H} as high as 400° C. at the outlet of the field of solar collectors 102. The working temperature of the primary heat transfer fluid 101 may be limited by the properties of the fluid itself, as the primary heat transfer fluid 101 may become chemically unstable at elevated temperatures. Typical heat transfer fluids used as the primary heat transfer fluid 101 are limited to temperatures of about 400° C. or less.

According to well-known thermodynamic principles, the efficiency with which power can be generated in the power block 103 depends on the temperature differential across which the power block 103 operates. In general, the higher the temperature of the first heat transfer fluid 101 entering the power block 103, the more efficient the power block can be. It is therefore desirable to increase the highest temperature in the system.

One prior approach to providing an increased temperature differential to the power block 103 has been to use a molten salt as the primary heat transfer fluid. A molten salt such as the second heat transfer fluid 109 illustrated in FIG. 1 may remain chemically stable and therefore usable at temperatures as high as 600° C. or more. In the example power plant 100 illustrated in FIG. 1, the second heat transfer fluid 109 is chosen primarily for its relatively high specific heat, so that substantial energy storage can be provided using a relatively small volume or mass of the second heat transfer fluid 109. However, in the illustrated power plant 100, the second heat transfer fluid never reaches a temperature higher than that of the primary heat transfer fluid 101, and the additional working temperature range of the second heat transfer fluid 109 is not utilized fully.

In a power plant using a molten salt as the primary heat transfer fluid, the molten salt would be circulated through the collector field, and heated temperatures as high as of 600° C. or more, and then used directly through the heat exchanger 105 to generate steam for the power block 103. Thus, using a molten salt as the primary heat transfer fluid would potentially enable a much larger temperature differential across the power block 103, and consequently would achieve an improved efficiency of the power block 103. The use of a molten salt as the primary heat transfer fluid may have other advantages as well, including reduced mass flow rate of the heat transfer fluid, reduced number of piping loops, reduced material and surface area in the collector field piping, as well as reduced cost of thermal energy storage.

However, the use of a molten salt as the primary heat transfer fluid presents certain difficulties. The melting temperature of the salt may be as high as 238° C. or more. If the fluid were allowed to freeze at any point in the system, that is, drop below 238° C., the power plant would be rendered inoperative. The plant may be damaged, and repairing and restarting the plant may take weeks. The field of solar collectors 102 may cover several square miles and is exposed to the atmosphere, and to avoid such damage the heat transfer fluid would need to be maintained at a temperature above the freezing temperature of the heat transfer fluid at all points in the system and at all times. To prevent freezing in a plant using a molten salt as the heat transfer fluid, the fluid may be constantly circulated through the system, and all piping, valves, fittings, and the like may be provided with backup heating devices in the event of pump failure, unusually cold weather, or other conditions that risk freezing of the molten salt. The heating devices add cost and complexity to the system, and when used, consume valuable power. Examples of heating devices include “heat tracing”, in which electric resistance heaters are placed in contact with pipes and other parts of the system, and impedance heating systems that may be used to heat collector tubes that must remain uncovered for proper collection of solar energy.

FIG. 2 illustrates a concentrating solar power plant 200 constructed in accordance with embodiments of the invention. The concentrating solar power plant 200 may provide at least some of the advantages of using a high temperature heat transfer fluid such as a molten salt, and may avoid some of the risk and cost of using such a heat transfer fluid.

The concentrating solar power plant 200 includes two fields of concentrating solar collectors. A first heat transfer fluid 201 circulates in a primary heating loop 220 through concentrating solar collectors 202 in a first field 203 of collectors. The first heat transfer fluid 201 may be driven by one or more pumps 222. The path of the primary heating loop 220 is indicated by a solid line, with arrowheads to indicate flow direction of the first heat transfer fluid 201. The first heat transfer fluid 201 may be a conventional heat transfer fluid having a maximum stable temperature of about 400° C. Examples of such fluids include a 73.5% diphenyl oxide (DPO) and 26.5% biphenyl eutectic mixture or a dimethyl polysiloxane fluid. The first heat transfer fluid 201 preferably remains liquid at temperatures below the environmental temperatures expected at the plant site. As such, no heat tracing or other backup heating measures are required in the first field 203 of the concentrating solar collectors 202.

The concentrating solar collectors 202 may be of any suitable type, for example parabolic trough collectors, Fresnel collectors, nonimaging collectors, or another kind of collector. The first collector field 203 may include a mixture of collector types. While only two collector modules are illustrated in FIG. 2, the field of collectors may include thousands of collector modules. At least some of the concentrating solar collectors 202 may rotate to track the sun throughout the day. The first heat transfer fluid 201 also circulates through a heat exchanger 204. When circulating through the first collector field 203, not all of first heat transfer fluid 201 may pass through all of concentrating solar collectors 202. For example, the concentrating solar collectors 202 may be grouped using a set of series and parallel connections, so that one portion of the first heat transfer fluid 201 leaving the heat exchanger 204 may pass through one set of the concentrating solar collectors 202, and another portion may pass through a different set of the concentrating solar collectors 202, before passing back to the heat exchanger 204. More detail about the construction of concentrating solar collectors suitable for use in some embodiments may be found in co-pending U.S. patent application Ser. No. 12/416,536 filed Apr. 1, 2009 and titled “Torque Transfer Between Trough Collector Modules”, the entire disclosure of which is incorporated by reference herein for all purposes.

The concentrating solar power plant 200 also comprises a second field 205 of concentrating solar collectors 206. The concentrating solar collectors 206 may be of the same type as the concentrating solar collectors 202, or may be of a different type. The second field 205 may include collectors of different types. A second heat transfer fluid 207 circulates through a secondary loop 224 through the second field 205, for example driven by pumps 226a and 226b. The path of the secondary heating loop 224 is indicated by a dashed line, with arrowheads to indicate flow direction of the second heat transfer fluid 207. The concentrating solar collectors 206 may be grouped using series and parallel connections, such that not all of the second heat transfer fluid 207 passes through all of the concentrating solar collectors 206 during circulation. The second field 205 of concentrating solar collectors 206 are an example of a secondary concentrating solar heater, providing secondary heating to the second heat transfer fluid 207, in addition to the heating provided by the first field 203 of the concentrating solar collectors 201.

The second heat transfer fluid 207 may be a molten salt or other high-temperature heat transfer fluid capable of operating at temperatures higher than the working temperature range of the first heat transfer fluid 201. The second heat transfer fluid 207 is also circulated to a power block 208, where electric energy is generated using thermal energy extracted from the second heat transfer fluid 207 using a second heat exchanger 209, which may be considered as part of the power block 208. In many embodiments, heat from the second heat transfer fluid 207 is transferred by the heat exchanger 209 to a working fluid 213 within the power block 208. The working fluid may be, for example, a liquid or a gas, or a combination thereof. For example, the power block 208 may utilize a steam-based Rankine cycle and the working fluid 213 may be steam. In other embodiments, the power block 208 may utilize a gas-based Brayton cycle, and the working fluid 213 may be a gas. Other power generation cycles are also possible. The second heat transfer fluid 207 then circulates back to the first heat exchanger 204, to begin the heating process anew. Hot and cold storage tanks 210 and 211, respectively, may be provided for storing thermal energy, for example for delayed electric power generation. The second heat transfer fluid 207 may be accumulated and held in the hot storage tank 210 during times of peak solar collection, and passed to the power generation block 208 at a later time.

Thus, the second heat transfer fluid 207 may be heated in two stages—first by heat exchanger 204 to a temperature near the maximum working temperature of the first heat transfer fluid 201, and then by the second collector field 205, to a temperature higher than the maximum working temperature of the first heat transfer fluid 201, and preferably to a temperature near the maximum stable working temperature of the second heat transfer fluid 207. The concentrating solar power plant 200 thus may provide the efficiency gain afforded by the extended working temperature range of the second heat transfer fluid 207, as compared with the working range of the first heat transfer fluid 201.

Because the first heat transfer fluid 201 used in the first field 203 of solar collectors does not risk freezing, a significant portion of the combined collector field does not require heat tracing or other backup heating. The complexity and cost of that portion of the system may thus be greatly reduced, as compared with a power plant in which a molten salt is utilized in all of the collector field. In addition, when backup heating is needed, the power consumed by the backup heating is reduced, because much less of the collective collector field requires backup heat. While the proportions of the solar collectors residing in the first collector field 203 and the second collector field 205 will depend on the design of a particular power plant, in some embodiments, the first collector field 203 may contain about 40-60% of the total number of concentrating solar collectors, with the remainder residing in the second collector field 205. In addition, the concentrating solar power plant 200 may provide other benefits of a higher-temperature heat transfer fluid, including reduced mass flow rate of the second heat transfer fluid 207, and reduced materials and surface area in the piping systems.

Also, the example concentrating solar power plant 200 provides direct thermal storage. That is, the hot and cold storage tanks 210 and 211 are placed in the piping loop that the second heat transfer fluid 207 traverses in its travel to and from the power block, and the second heat transfer fluid 207 flows directly into and out of the hot and cold storage tanks 210 and 211. This is in contrast to the concentrating solar power plant 100 of FIG. 1, where thermal energy is transferred to and from the thermal storage using the heat exchanger 110. The concentrating solar power plant 200 of FIG. 2 may largely avoid losses inherent in the indirect transfer of thermal energy to and from storage.

The concentrating solar power plant 200 may provide reliability benefits as well. In addition to the reduced complexity of part of the collector field, an optional bypass 212 may be provided, having two configurations. For example, valves 214 and 215 or another kind of switching device may be configured for routing the second heat transfer fluid 207 through the bypass or through the second collector field 205. In a first configuration, the bypass 212 is not utilized (valve 214 is open and valve 215 is closed), and the second heat transfer fluid 207 circulates through the second field 205 of concentrating solar collectors 206, the hot storage tank 210, the power generation block 208 (which includes the heat exchanger 209), the cold storage tank 211, and the heat exchanger 204. In the second configuration, the bypass 212 is utilized (valve 214 is closed and valve 215 is open), and the second heat transfer fluid 207 circulates through the heat exchanger 204 and the power generation block 208 without circulating through the second field 205 of concentrating solar collectors 206. In the second configuration, the concentrating solar power plant 200 may be operated at reduced capacity and efficiency while the second field 205 of concentrating solar collectors 206 is offline for maintenance or repair. In the second configuration, only a relatively small piping loop carrying the second heat transfer fluid 207 is kept active, carrying the second heat transfer fluid 207 between the first heat exchanger 204 and the power generation block 208, through the hot and cold storage tanks 210 and 211.

In addition to the reduced-capacity mode of operation described above, utilizing the bypass 212 and heating the second heat transfer fluid 207 only via heat exchange from the first heat transfer fluid 201 circulating in the first field 203, it will be recognized that another reduced-capacity mode may also be possible in some embodiments. In this second reduced-capacity mode, the bypass 212 is not utilized (valve 214 is open and valve 215 is closed), so that the second heat transfer fluid 207 circulates through the second field 205 to be heated by the collectors 206 in the second field 205, through the hot storage tank 210, and through the power block 208 where power is generated using heat transferred from the second heat transfer fluid 207. The second heat transfer fluid 207 may further circulate from the power block 208, through the cold storage tank 211, through the heat exchanger 204, and back to the second collector field 205 for re-heating. (Alternatively, a second bypass 227 may be provided so that second heat transfer fluid 207 can bypass the heat exchanger 204, for example under control of valves such as valves 228 and 229.) In this second reduced-capacity mode, the first field 203 of collectors may not be operational, and may not provide any heat to the second heat transfer fluid 207. In this second reduced-capacity mode, only the second field 205 of collectors provides heating. This mode may be used, for example, when the first field 203 of collectors is not operational, for example when the first field 203 of collectors is undergoing maintenance or is experiencing a temporary equipment failure. Thus, the example concentrating solar power plant 200 may be operated such that both collector fields 203 and 205 contribute to heating the second heat transfer fluid 207, or in either of two other modes in which only one of the two collector fields 203 or 205 contributes to heating the second heat transfer fluid 207.

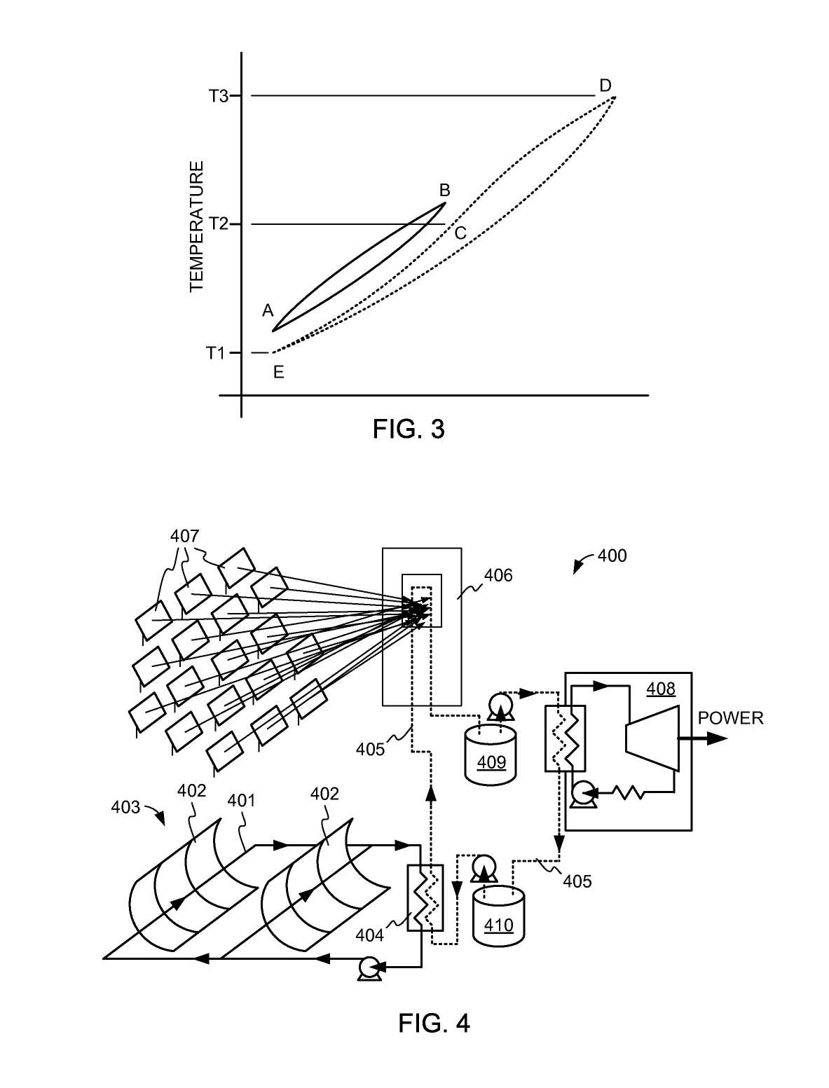

FIG. 3 shows example temperature histories of the first and second heat transfer fluids 201 and 207 as they circulate within the system. The first heat transfer fluid 201 enters the first collector field 203 at or near its lowest temperature, at the point labeled “A” in FIG. 2, and it exits the first collector field 203 at its highest temperature, at the point labeled “B” in FIG. 2. The temperature conditions corresponding to points A and B are also labeled as “A” and “B” in FIG. 3. The first heat transfer fluid 201 is then cooled in the first heat exchanger 204, as it imparts heat to the second heat transfer fluid 207.

The second heat transfer fluid 207 enters the first heat exchanger 204 at or near its lowest temperature T1, at the point labeled “E” in FIG. 2. The first heat exchanger 204 raises the temperature of the second heat transfer fluid 207 to a temperature T2 at the exit of the first heat exchanger 204, at the point labeled “C” in FIG. 2. The second heat transfer fluid 207 is then heated in the second collector field 205 and exits the second collector field 205 at or near its highest temperature T3, at the point labeled “D” in FIG. 2. The temperature conditions corresponding to points C, D, and E are also labeled as “C”, “D”, and “E” in FIG. 3. The second heat transfer fluid 207 may then enter the hot storage tank 210, which may be maintained at a temperature near T3. The second heat transfer fluid 207 is then cooled as it passes through the power generation block 208, back to a temperature near T1, and enters the cold storage tank 211. The cold storage tank 211 may be maintained at a temperature near T1.

While the temperatures involved will vary with operating condition, the particular heat transfer fluids used, and the design of a particular power plant, in some embodiments T1 may be on the order of 300° C., T2 may be on the order of 400° C., and T3 may be on the order of 550-600° C.

FIG. 4 illustrates a concentrating solar power plant 400 in accordance with other embodiments. Like power plants 100 and 200 described above, the concentrating solar power plant 400 uses a first heat transfer fluid 401 circulating through a field 403 of concentrating solar collectors 402, and a heat exchanger 404 that imparts heat from the first heat transfer fluid 401 to a second heat transfer fluid 405. As above, the second heat transfer fluid 405 may have a higher maximum working temperature than the first heat transfer fluid 401. For example, the second heat transfer fluid 405 may be a molten salt.

Once the second heat transfer fluid 405 has been heated in the heat exchanger 404, it passes to a secondary concentrating solar heater for further heating. In the embodiment of FIG. 4, the second heat transfer fluid 405 passes to a solar “power tower” 406 where it is heated by solar radiation reflected from a field of mirrors 407. Mirrors 407 track the sun such that each mirror reflects solar radiation to a receiver at power tower 406 and the accumulated reflected radiation produces very high energy flux at power tower 406. The mirrors 407 may be called heliostats. Once heated, the second heat transfer fluid 405 passes to a power generation block 408, where electrical power is generated utilizing heat extracted from the second heat transfer fluid 405 via a second heat exchanger 411. The second heat exchanger 411 transfers heat to a second working fluid 412 within the power block 408. The second working fluid 412 may be a liquid or a gas, or a combination thereof. The second heat transfer fluid 405 then returns to the heat exchanger 404 to start the heating cycle anew. Hot and cold storage tanks 409 and 410 may be provided for energy storage. By utilizing the field 403 of the concentrating solar collectors 402 and the heat exchanger 404 to preheat the second heat transfer fluid 405 prior to its further heating in the power tower 406, a larger amount of heat transfer fluid 405 may be heated to a higher working temperature than would otherwise be possible with a practicably sized field of mirrors 407. A bypass 413 may be provided, similar to the bypass 212 shown in FIG. 2. Circulation of the second heat transfer fluid 405 through the power tower 406 may be enabled or disabled by proper setting of valves 414 and 415. Similarly, a bypass 416 may be provided, similar to bypass 227, and enabled and disabled by valves 416 and 417. Thus, the concentrating solar power plant 400 can be operated in a reduced efficiency mode if desired. It will be recognized that the depiction of the concentrating solar power plant 400 is highly schematic. Other arrangements using one or more heliostats and a receiver may be used.

The present invention has been described above in terms of presently preferred embodiments so that an understanding of the present invention can be conveyed. There are, however, many configurations for solar power generation systems not specifically described herein but with which the present invention is applicable. The present invention should therefore not be seen as limited to the particular embodiments described herein, but rather, it should be understood that the present invention has wide applicability with respect to collector systems generally. All modifications, variations, or equivalent arrangements and implementations that are within the scope of the attached claims should therefore be considered within the scope of the invention.

What is claimed is:

1. A solar power generation system, comprising:
a field of concentrating solar collectors;
a heat exchanger;
a first heat transfer fluid circulating through the field of concentrating solar collectors such that the first heat transfer fluid is heated by the field of concentrating solar collectors, and wherein the first heat transfer fluid also circulates through the heat exchanger;
a secondary concentrating solar heater;
a power generation block; and
a second heat transfer fluid circulating through the secondary concentrating solar heater, the heat exchanger, and the power generation block;
wherein the heat exchanger imparts heat to the second heat transfer fluid from the first heat transfer fluid to heat the second heat transfer fluid from a first temperature to a second temperature;
and wherein the secondary concentrating solar heater heats the second heat transfer fluid from the second temperature to a third temperature;
and wherein the power generation block generates electrical power utilizing thermal energy extracted from the second heat transfer fluid.

2. The solar power generation system of claim 1, wherein the second heat transfer fluid is a molten salt.

3. The solar power generation system of claim 2, wherein the first heat transfer fluid has a maximum usable operating temperature of less than 450° C.

4. The solar power generation system of claim 2, wherein the first heat transfer fluid has a maximum usable operating temperature, and wherein the second heat transfer fluid is heated in the secondary concentrating solar heater to a temperature higher than the maximum usable operating temperature of the first heat transfer fluid.

5. The solar power generation system of claim 1, further comprising:
a hot storage tank; and
a cold storage tank;
wherein the second heat transfer fluid flows from the secondary concentrating solar heater to the hot storage tank, and then to the power generation block;
and wherein the second heat transfer fluid flows from the power generation block to the cold storage tank and then to the heat exchanger.

6. The solar power generation system of claim 1, wherein the field of concentrating solar collectors comprises collectors of one or more types selected from the group consisting of parabolic trough solar collectors, Fresnel collectors, and nonimaging collectors.

7. The solar power generation system of claim 6, wherein the field of concentrating solar collectors comprises at least one parabolic trough solar collector.

8. The solar power generation system of claim 6, wherein the field of concentrating solar collectors comprises collectors of more than one type.

9. The solar power generation system of claim 1, wherein the secondary concentrating solar heater comprises a second field of concentrating solar collectors.

10. The solar power generation system of claim 9, wherein the second field of concentrating solar collectors comprises at least one parabolic trough solar collector.

11. The solar power generation system of claim 1, wherein the secondary concentrating solar heater comprises a field of mirrors that reflect solar radiation to a common location, and wherein the second heat transfer fluid circulates through the common location, the heat exchanger, and a power generation block.

12. The solar power generation system of claim 1, further comprising a bypass of the secondary concentrating solar heater, and wherein:
when the bypass is not utilized, the second heat transfer fluid circulates through the secondary concentrating solar heater, the heat exchanger, and the power generation block; and
when the bypass is utilized, the second heat transfer fluid circulates through the heat exchanger and the power generation block without circulating through the secondary concentrating solar heater.

13. The solar power generation system of claim 1, further comprising a bypass of the heat exchanger, and wherein:
when the bypass is not utilized, the second heat transfer fluid circulates through the heat exchanger, the secondary concentrating solar heater, and the power generation block; and
when the bypass is utilized, the second heat transfer fluid circulates through the secondary concentrating solar heater and the power generation block without flowing through the heat exchanger.

14. The solar power generation system of claim 1, wherein the power generation block uses a working fluid, and wherein the working fluid is heated using at least some of the thermal energy extracted from the second heat transfer fluid.

15. A method of generating electrical power, the method comprising:
passing a first heat transfer fluid through a field of concentrating solar collectors to heat the first heat transfer fluid;
passing the first heat transfer fluid through a heat exchanger to impart heat to a second heat transfer fluid;
passing the second heat transfer fluid through a secondary concentrating solar heater to further heat the second heat transfer fluid;
passing the second heat transfer fluid to a power block that generates electrical power utilizing thermal energy extracted from the second heat transfer fluid; and
passing the second heat transfer fluid back to the heat exchanger to be re-heated.

16. The method of generating electrical power of claim 15, wherein the first heat transfer fluid is heated by the field of concentrating solar collectors to a maximum temperature less than 450° C.

17. The method of generating electrical power of claim 15, wherein the second heat transfer fluid is heated by the secondary concentrating solar heater to a temperature greater than 450° C.

18. The method of generating electrical power of claim 15, wherein the second heat transfer fluid is heated by the secondary concentrating solar heater to a temperature greater than the maximum usable operating temperature of the first heat transfer fluid.

19. The method of generating electrical power of claim 15, further comprising passing the second heat transfer fluid through a hot storage tank during flow of the second heat transfer fluid from the secondary concentrating solar heater to the power block.

20. The method of generating electrical power of claim 15, further comprising passing the second heat transfer fluid through a cold storage tank during flow of the second heat transfer fluid from the power block to the heat exchanger.

21. The method of generating electrical power of claim 15, wherein passing the second heat transfer fluid through a secondary concentrating solar heater comprises passing the second heat transfer fluid through a second field of concentrating solar collectors.

22. The method of generating electrical power of claim 15, further comprising directing solar radiation to a common location from a field of mirrors, and wherein passing the second heat transfer fluid through a secondary concentrating solar heater comprises passing the second heat transfer fluid through the common location.

23. The method of generating electrical power of claim 15, wherein the power block uses a working fluid, and wherein the method further comprises heating the working fluid using at least some of the heat extracted from the second heat transfer fluid.
